(19) United States
(12) Patent Application Publication
(10) Pub. No.: US 2012/0278412 A1
(43) Pub. Date: Nov. 1, 2012

(54) METHOD AND SYSTEM FOR MESSAGE DELIVERY EMPLOYING THIRD PARTY INFLUENCES

(76) Inventors: Tom Walsh, Tecumseh, MI (US); Steven J. Catani, Athens, GA (US); Maurice Collins, Chelsea, MI (US); Lauren Didyk, Plymouth, MI (US); Helene Gidley, Ann Arbor, MI (US); David Gregorka, Ann Arbor, MI (US); John Hetrick, Ann Arbor, MI (US); Jeff Matthes, Ypsilanti, MI (US); Tom Sox, Ambler, PA (US); Victor Strecher, Ann Arbor, MI (US)

(21) Appl. No.: 13/457,861

(22) Filed: Apr. 27, 2012

Related U.S. Application Data
(60) Provisional application No. 61/480,408, filed on Apr. 29, 2011.

(51) Int. Cl. G06F 15/16

(52) U.S. Cl. 709/206

(57) ABSTRACT

A method and system for providing personalized message delivery to one or more users is disclosed. In accordance with the method and system, data descriptive of two or more events in the one or more users' lives is gathered, analyzed and used to determine priority of messages; and personalized message delivery is provided to the one or more users based upon the priority of messages. The method and system may employ the two or more events to correlate [holistic messages] considered important by the user. The method and system may also employ third party influences when generating the messages.

### CROSS-REFERENCE TO RELATED APPLICATIONS

This application claims priority from U.S. Provisional Application Ser. No. 61/480,408, filed Apr. 29, 2011, the contents of which are hereby incorporated by reference in their entirety.

### FIELD OF THE INVENTION

The present invention relates to a method and system for providing message delivery to one or more users. The method and system, which employ user events and third party influences, are particularly useful in the correlation of messages considered important for the user (as determined both by user input and by systematic input).

### BACKGROUND OF THE INVENTION

Different methods and/or systems for the delivery of information to individuals are known. For example, U.S. Pat. No. 7,949,712 to AT&T Intellectual Property L.L.P., discloses a method for deploying a high availability presence engine for instant messaging that includes: receiving a user's presence change information in a global table; updating the global table to reflect the change in the user's presence information; and sending updated presence information on the user to local tables of contacts affected by the change in the user's presence; and U.S. Pat. Nos. 7,756,744 and 7,895,078 to Dotomi Inc. disclose a method for messaging over a data network, comprising: i) providing an Administration Server (AS) in which user portfolios are stored, said AS being in communication with a terminal belonging to a user; ii) allowing every registered user to generate and update one or more user portfolio(s) containing information relative to Providers and/or individuals the messages of which the user is willing to view; and iii) displaying to one or more users on their terminal messages according to the information contained in the user portfolio. While many of these methods and/or systems provide information to the user, they lack the intuitiveness to decide when the message will be most effective, based on learned patterns, user feedback, lack of user feedback and user preferences as well as what the content of the message should be.

Different methods and/or systems for assisting communication between members of a team are also known. For example, U.S. Pat. No. 8,069,131 to Luechtefeld et al. discloses an artificially intelligent or rule-based system to assist teams or groups by improving the communication process between members of the team or group. U.S. Pat. No. 7,996,257 to International Business Machines Corporation (hereinafter referred to as IBM) discloses mechanisms for collecting, calculating, and reporting quantifiable peer feedback on relative contributions of team members. U.S. Pat. No. 7,584,114 to IBM discloses a method for integrating project events on a team collaboration server with personal calendars. U.S. Pat. No. 7,072,940 to Ford Motor Company discloses methods and apparatus for managing data and information between diverse organizations and data management systems.

U.S. Published Application No. 20120036015 to Sheikh discloses a method to improve the relevancy of rendered advertising material to one or more consumers based on user-defined preferences, geolocation, and user-granted permission.

U.S. Published Application No. 20110112881 to Malhotra et al. discloses a system and method for helping users perform and manage actions on their to-do lists tasks by making it fun, rewarding and engaging. Malhotra et al. discloses that the system and method facilitate the interaction of a user with to-do list task items with those who can influence the user to take action and those that stand to benefit from the performance of the to-do list task items.

Effective communication is vital. While the methods and/or systems discussed above may assist communication, they do not provide a method and/or a system that employs events and third party influences to prioritize and correlate messages considered relevant for a user (as determined both by user input (passive, not active) and by systematic input (learnings).

### SUMMARY OF THE INVENTION

The present invention is directed to a method for providing personalized message delivery to one or more users, comprising: gathering data descriptive of two or more events in the one or more users life, wherein said data is received from two or more sources, wherein said two or more sources include at least one third party, and wherein said at least one third party influences said personalized message delivery; analyzing said data and said at least one third party influence to determine priority of said messages; and providing said personalized message delivery to said at least one user.

The present invention is also directed to a system for providing personalized message delivery to one or more users, comprising: at least one user interface; a server, wherein said server comprises software, wherein said software gathers data descriptive of two or more events in the one or more users life, analyzes said data to determine priority of messages, and employs said priority of messages to determine personalized message delivery of said messages to said one or more users; wherein said data is received from two or more sources, wherein said two or more sources include at least one third party, and wherein said at least one third party influences said personalized message delivery; and a transmitter in communication with said processor and said at least one user interface, wherein said transmitter provides said personalized message delivery of said messages to said one or more users through the at least one user interface.

### DESCRIPTION OF THE DRAWINGS

FIG. 1 is a flowchart showing an example of a method and system for providing message delivery to one or more users that may be used in accordance with the present invention.

FIG. 2 is a schematic that illustrates in more detail steps and the corresponding factors of those steps that may be implemented when using the method and system of the present invention.

FIG. 3 is a schematic that illustrates a general sequence of events that may be followed when using the method and system of the present invention.

FIG. 4 is a schematic that illustrates a server that may be employed when using the method and system of the present invention.

### DETAILED DESCRIPTION OF THE INVENTION

The present invention provides a method and system to correlate messages corresponding to events and input from third parties. The method and system of the invention permit effective communication to a user.

### Definitions

Unless defined otherwise, all technical terms used herein have the same meaning as commonly understood by one of ordinary skill in the art to which the invention belongs. Also, all publications, patent applications, patents, and other references that may be mentioned herein are incorporated herein by reference.

“Economic Buyer” as used herein Economic Buyer generally includes an entity that promotes and/or sponsors a user's participation in a program that is based upon a common theme. For example, an Economic Buyer can be an employer, a health plan, a third party administrator, and/or a pharmaceutical company who pays for the program and/or selects and/or determines the scope of enrollment of the user in the program.

“Event(s)” as used herein Event(s) is/are data input to the system that is derived from various sources, including, but not limited to, user input.

“Geo-Social Data” as used herein Geo-Social Data includes data from the assessment of locations recorded using location-acquisition technologies (e.g., GPS, phone “check in” applications, etc.) that allow generating life patterns, and which associate a user to places he/she frequently visits. Geo-Social Data includes Normative Data that corresponds to a specific location, or to similar locations.

“Holistic Message” as used herein a Holistic Message is generally a more eloquently constructed message that is worded in such a way that pieces are not merely strung together but rather construction of the message as a whole is based on the sum of its parts. Messages are “holistically” created, as compared to the current form of “tailored” messages, which are more like a series of prescripted messages packaged together in a logical way.

“Importance Score” as used herein Importance Score generally includes a method of prioritizing Events and Correlated Events messages. For example, it may include a method of assigning a numerical value to each specific Event or collectively to a group of Correlated Events for prioritization.

“Just in Time Message (‘JIT Message’)” as used herein JIT Message is a personalized response that may be made in message form, advertisement, reminder, etc., which is conveyed effectively to the user by prioritizing and correlating the message using specific pertinent data prior to the conveyance. As indicated below, Just in Time indicates that the delivery is at the appropriate time, frequency, tone, method and/or mode of delivery for the message content in accordance with User's Preferences (includes both internal and external input).

“Network Access Device” as used herein means a device for accessing a communications network capable of transmitting and receiving digital data.

“Normative Data” as used herein Normative Data includes data which represents the normal or average response or impact from any given event, (e.g., news, etc.), across various levels, (e.g., age, sex, etc.), used to compare a user's response with an objective external standard. Normative Data can also include data contained in available databases that provide population level data as a reference point.

“Now State” as used herein Now State means the best time, frequency, tone, method and/or mode for delivery of a message to a user as determined by an input describing the user's state of mind at a fixed point in time. The input could be from user input or derived from a reporting device.

“Overseer” as used herein an Overseer refers generally to a monitor for the Pre-determined Third Party. The Overseer may be a person or an algorithm that controls what messages are being sent and to whom. The Overseer may act as a filter, e.g., to prevent inappropriate messages coming from the Pre-selected Third Party. For example, the Economic Buyer may have a strict human resources (HR) policy that prevents certain types of messages from being generated. The Overseer could perform screening on messages in light of certain rules, evaluate the messages and accept, reject or adjust the messaging so it is appropriate given the environment/spirit in which it is being sent.

“Pre-determined Third Party” as used herein a Pre-determined Third Party may be a pre-selected team leader, party organizer, counselor, inspirational storyteller, Economic Buyer, etc. The Pre-determined Third Party may be selected by the Economic Buyer, the system itself, and/or the User. The function of the Pre-determined Third Party may be to motivate and direct the User(s). For example, the Pre-determined Third Party could motivate and organize people in an organization to, e.g., do good things, be healthy, be happy, be full of energy, etc.

“Present Responsiveness” as used herein Present Responsiveness is a determination of whether or not and how frequently a user responds to certain modalities and messages in order to determine the effectiveness of the messages.

“Real Time” as used herein means a process, action or transaction that involves updating information without artificial delay, i.e., at the same rate that the information is received.

“Smart Team Message(s)” as used herein a Smart Team Message is a communication to a User(s) that incorporates User's Preferences and a team's characteristics/objectives to convey a message in a personalized and effective way by providing correlated and prioritized message delivery.

“Source Agnostic” as used herein Source Agnostic refers to all data being treated as input “events” without regard for their source. The data is formatted in a way that is not specific to its source (e.g., using standard protocols such as XML). The system may also use data from sources such as GPS location for mobile users; weather information; geographical information; local events; time and date; news and current news, as well as the systems current sources (behavioral science, health and wellness, medical, health plan, employer data, etc.). This does not mean all data points are equal. Data is differentially weighted to impact how it is prioritized and/or used to construct messages.

“Team” as used herein a Team generally includes individuals that share a set of qualities/characteristics used to achieve a common goal or target. E.g., athletic teams, business teams, support groups, members of an entity, etc.

“Third Party Dashboard” as used herein the Third Party Dashboard includes a user interface designed for the Pre-determined Third Party message indicator. For example, in some applications a manager of a group could log on and send a message to the group. In other applications, a coach could log on and send a message to his/her team. However, unlike conventional systems, limited functionality is afforded through the Third Party Dashboard based on stakeholder input. Stakeholders or administrators using the Third Party Dashboard would be able to select from a full list of features in order to arrange the interface to serve the needs of different user profiles.

“Transport Agnostic” as used herein Transport Agnostic includes data formatted to be used by multiple systems or devices (meaning standard data types and protocols are used so as not to restrict the data for any given system). Taken a step further, currently a user getting an e-mail may have a slightly different message than someone who accesses his/her information on the web. The system can ensure that the message(s) are formatted so that the meaning (core message) of the content is the same regardless of how they are received/transported.

“User” as used herein a User may be a person, team, company, or organization interacting with the message delivery system.

“User's Preferences” as used herein User's Preferences are the preferences of a specific user as to the timing, frequency, message tone, method and/or mode of receiving/sharing information. The present invention provides a system and method of determining and implementing user preferences, goals and objectives, for the delivery of Smart Team Messages.

Commonly assigned co-pending U.S. application Ser. No. 13/283,039, filed on Nov. 27, 2011, entitled “METHOD AND SYSTEM FOR PERSONALIZED MESSAGE DELIVERY”, the entire contents of which are incorporated herein by reference, provides a method and system for determining and implementing user preferences, normative data, location, and time, including, e.g., time of day, day of week and month of year, for the delivery of Just in Time Messages in a way innocuous to the user.

Commonly assigned co-pending U.S. application Ser. No. 13/336,080, filed on Dec. 23, 2011, entitled “METHOD AND SYSTEM FOR AUTOMATED TEAM SUPPORT MESSAGE DELIVERY”, the entire contents of which are incorporated herein by references, provides a method and system for providing message delivery to one or more members of one or more teams of users.

The method and system of the invention employs user events and third party influences, and is thus particularly useful in the correlation of messages considered relevant for a user (as determined both by user input (passive, not active) and by systematic input (learnings)).

The invention is exemplified in the examples below.

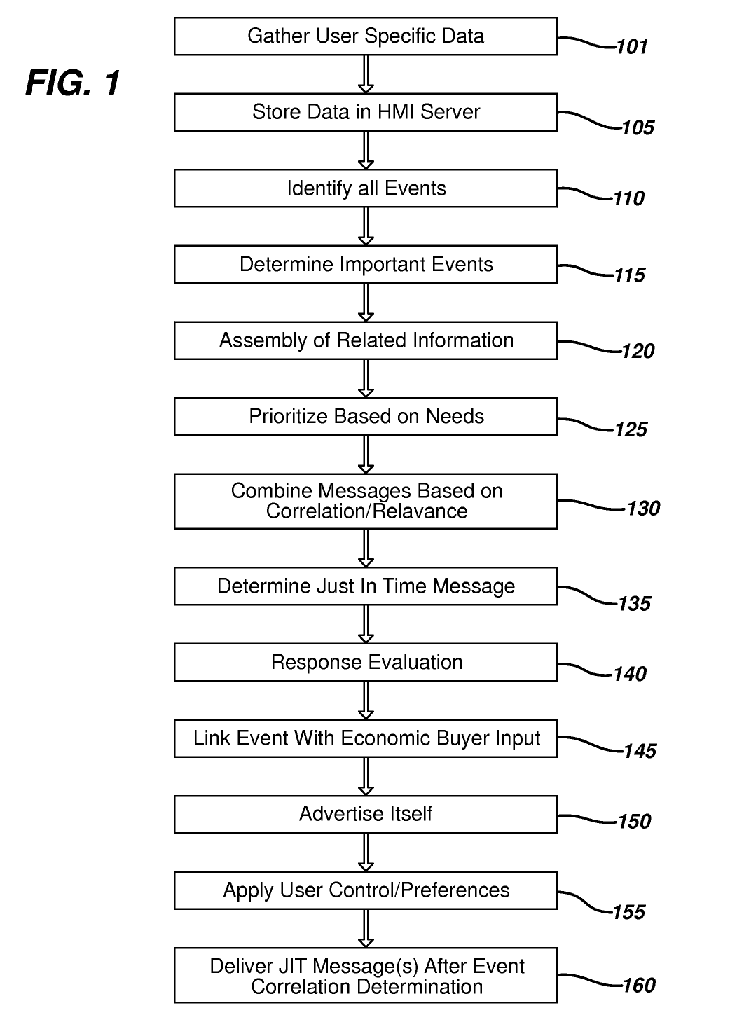

FIG. 1 is a flowchart showing an example of a method and system for providing message delivery to one or more users that may be used in accordance with the present invention.

Referring to FIG. 1, people's time and attention span is limited. As such, for effective message construction, delivery, and assimilation, it would be useful to correlate electronic messages influenced by Pre-determined Third Parties to Events in the life of each particular User. According to an embodiment of the invention, at 101 the system gathers data specific to each User continuously. Data may come into a server from direct or indirect inputs, from the User, from a Pre-determined Third Party, and/or from different non-users, through one or more of an array of different Network Access Devices. At 105, data received in a consistent format and in Real Time can be supported by the system and may be stored in a designated database in the server. At 110, the data received may be classified to indentify past events and/or anticipate upcoming events in the life of the User. After specific events are identified, Events may then be linked with different behavioral topics by the system using User specific and Pre-determined Third Party data to determine an Importance Score for each Event generated 115. Upon formulating an Importance Score, at 120, the system may begin to combine related information to assemble one or more Holistic Messages, decreasing the number of messages and maximizing the effectiveness of the messages for the User.

At 125, the needs and/or User's Preferences can also be used by the System to prioritize the message(s). The needs may also be influenced by Pre-determined Third Parties. A Pre-determined Third Party should be the person who is best equipped to be the leader in health related initiatives and act as an administrator for the Third Party Dashboard. For example, the Pre-determined Third Party in a company may be the person who knows everyone by name, knows about their families, their work struggles, etc. and generally cares about everyone in the office. However, input can be controlled by the system so that the information is in harmony with the goal, principle, overall functionality of the message, etc., by means of an Overseer. E.g., the Overseer may specify to the system the type of message the Pre-determined Third Party wants to send out on a particular day. Additionally, the system may include a medical consultant that can evaluate the content periodically or continuously for accuracy and relevance, and inputs new data into the system based on the latest research specific to sub-set of a population. The medical consultant can also use behavioral science and medical principles to further ensure that the content of the message maximizes the effectiveness of the message and provides the intended influence of the respective Pre-determined Third Party.

Further prioritization can occur and electronic messages may be generated and scheduled for delivery sequentially to specific future Events with a high probability of occurring 130. At 135, a JIT Message determination may also be implemented to determine effective means of delivery. At 140, the user or other comparable individual(s)' response(s) to an identical or similar message can generate data resulting from the effectiveness it has on the individual, which may be recorded for implementation in future determinations of content and delivery of electronic messages.

Additional features may be implemented by the system. For example, the User's Events and scope of participation can be limited by an Economic Buyer. The Economic Buyer can have power to customize the program causing it to focus on selected behavioral topics and/or elected Events 145 (i.e., Event influenced electronic messages). The Economic Buyer may also use the system to “advertise itself” 150. The “advertise itself” option can allow the incorporation of pre-selected messages by the Economic Buyer into the program. The User's Preferences may also be merged with the Economic Buyer's settings to correlate events and scope of participation of the User 155. The system subsequently may cause the delivery of JIT Message(s) that are correlated with Events 160 providing effective conveyance of Holistic Messages to the User.

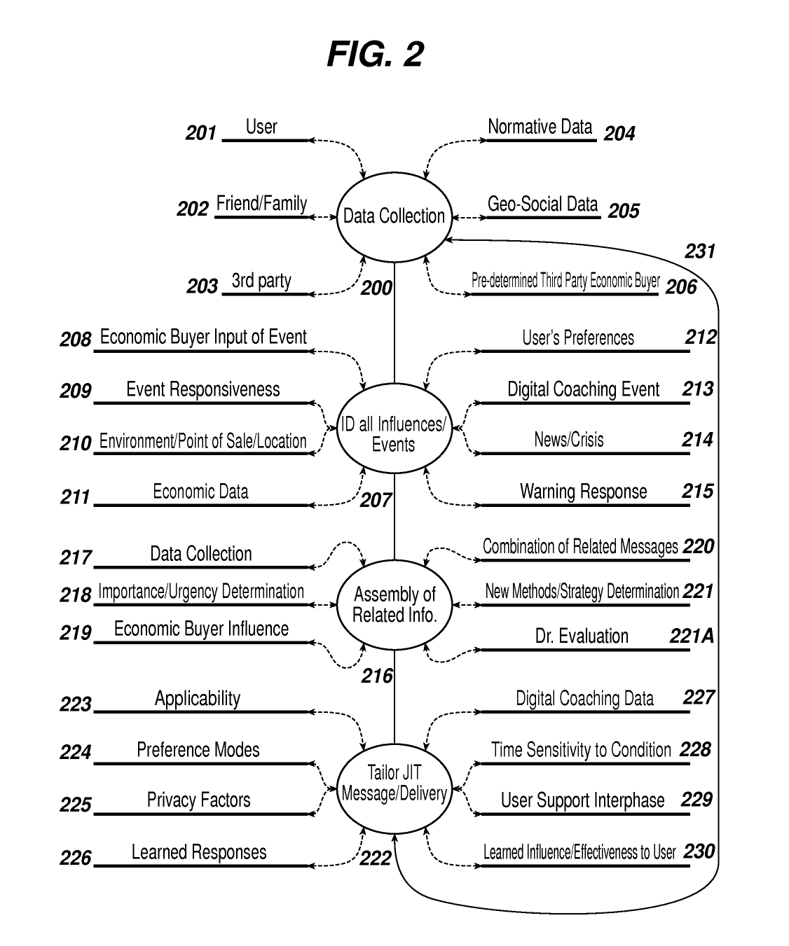

FIG. 2 is a schematic that illustrates in more detail steps and the corresponding factors of those steps that may be implemented when using the method and system of the present invention. Referring to FIG. 2, at 200, data collection applicable to the User can include data received from different avenues. The data received must be in a consistent format and in real time. The User 201 can supply data to the Network Access Device in different ways. User supplied data includes but is not limited to data taken from web/paper questionnaires/consultations, medical devices, wireless devices, PC, employers, etc.

Friends and family 202 may also provide relevant information about the User through different/same mediums. They can express concerns or provide valuable information about the User through any medium supported by the system. An example of a medium that may be implemented without burdening this group is social networks. Social networks are used every day and may provide Source Agnostic information about the User in Real Time without requiring additional effort from friends and family.

Other third parties 203 may also provide helpful and in some applications valuable data to the system. If not selected as the Pre-determined Third Party and/or the medical consultant, other third parties who may additionally provide input include the user's Economic Buyer, physician, coach, co-worker, manager, project manager, etc. These third parties, who can provide data in everyday situations using mediums supported by the system, may give useful/essential data to the system for specific topics. For example, in one scenario where a third party notices or notes a change in the individual's activities, preferences, or behavior, the system may detect the change from the data provided by the third party. In another scenario, the Economic Buyer 206 and/or the Pre-determined Third Party may elect certain behavioral topics, assessments, modes, etc. for implementation by the system. In some applications, because the Economic Buyer has the ability to input information that influences the User(s), the influence can be stratified to the appropriate groups using the Economic Buyer as the Pre-determined Third Party. For example, where the doctor is the Economic Buyer and has a closed health care plan, he/she can send a message to his patients in the group.

Normative Data 204 and Geo-Social Data 205 can also help identify, correlate and associate responsiveness of messages to particular Events and/or Team goals/objectives. An example of where Normative Data may be useful includes data collected from a reaction to an Event from a particular group of people who share similar characteristics. The system can categorize, prioritize and correlate the data received which resulted from the reaction to the Event into the Importance Score determination. Finally, data generated from the response and effect of these, Smart Team Messages and/or JIT messages is Source Agnostic and/or Transport Agnostic, which may be used by the system to determine User Preferences for future interaction and Holistic Messages.

Essentially, the influence of the Pre-determined Third Parties and others may turn to specific and general Events in Users' lives. Using algorithms capable of applying sets of factors and Correlation Scores, the system may identify those Events important to the user 207. Events can subsequently be tagged/categorized using the additional factors. Additional factors that can influence electronic messages may include but are not limited to; Economic Buyer input of Events 208, responsiveness to an Event 209, location/environment where an Event takes place 210, economic data 211, User's Preferences 212, a digital coaching Event created by the system 213, current news data 214, responses to Event warnings 215, etc. These factors for the Importance Score determination can be programmed into the algorithms in the server and the system can allow inputs from the monitoring party for the modification of these to maximize the effectiveness of the program.

After obtaining the Correlation Score for identified Events, the system can gather pertinent information for Holistic Message assembly using the information collected and stored in the system's databases 216. The content of the message may be determined using the Event(s)' information/data 217. Behavioral science inputs can allow for an Importance Score determination for the information/data. The Importance Score determination will manipulate the content of messages and the priority among the messages generated 218. Other things can also be used for content and priority determination. For example, an Economic Buyer may manipulate the content of the message 219. An example of how/when this may occur is when the Economic Buyer chooses to advertise itself by selecting preselected messages from the system.

After the content and priority determination, the system can use a Message Combine 220 to provide Holistic Message(s), which can minimize the amount of messages and increase the probability of effective reception of the message by the User. Using behavioral science, the system can also strategize the messages and provide new methods of delivery generating data to tailor the delivery and content of future messages 221. For example, in some applications, a Holistic Message can be Event triggered by the manager but delivered by the Pre-determined Third Party influence to ensure a positive effective message results. At 221A, the Overseer and/or the medical consultant can additionally review the functionality of the message and allow it if desired. For example, the system can include a filter/search function with drag in data elements to build the message, so where a message is to be targeted to men over 40 and colon health, the medical consultant can assist in crafting the message using the latest studies pertaining to colon health in men over 40.

The conveyance timing and method of the message may be tailored to the user using JIT Messaging 222. Determining the applicability of the message to a respective activity the user may be performing/taking part in, can ensure that the message is engaging, thus maximizing the effectiveness of the message 223. For example, by using the data collected to track the User's everyday activities, the system can correlate specific messages with high probability occurring activities to specific times of the day, month, etc. The User Preferences and access to devices at specific times is also taken into account in the delivery 224. For example, it can be determined that the User has access to a computer during workday hours specific to the User. Additionally, privacy factors and access to information can be protected to protect the individual's privacy and ensure truthful participation of the User 225. The system may also be able to learn responses from the User and shape the program accordingly 226.

Digital coaching may also be possible 227. The Economic Buyer, Pre-determined Third Party, or system can recommend or assign a coach or a digital “buddy” for encouragement. The interaction of more than one User in the program can be done by invitation and be known to other Users, or can remain anonymous if desired. Coaches may also be recruited by the system based on performance and data inputted/collected from them is weighted for the electronic messages accordingly.

At 228, the participation of the User may be tracked and time factors specific to the user can be implemented in the delivery of the message. For example, for some Users it may be more effective to convey the message as close to the occurrence of the Event vs. others, as soon as possible to allow for anticipation and preparation accordingly. User Preferences can also be adapted through user support interfaces that allow for unexpected changes 229. Learned influences and effectiveness to user after change can be tracked and recorded for future assessment increasing effectiveness of the system with time 230, 231.

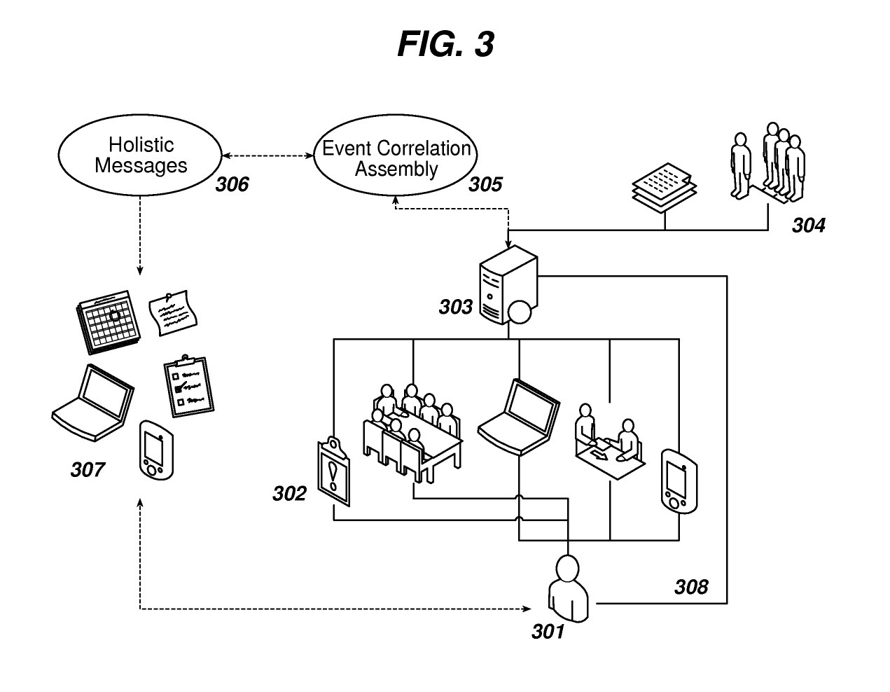

FIG. 3 is a schematic that illustrates a general sequence of events that may be followed when using the method and system of the present invention. Referring now to FIG. 3, the User 301 of the system directly or indirectly provides data through different avenues 302. The data is gathered by a server 303, which also collects other information 304 that includes but is not limited to Normative Data and Geo-Social Data as explained above. The server contains software executable to perform the functions described above providing Event Correlated Messaging 305 for the delivery of Holistic Message(s) to the User(s) 306. The message can be conveyed using the User Preferred means for the message and collect Present Responsiveness data throughout to update/increase preciseness of the systems functions for subsequent prospect messages [307, 308].

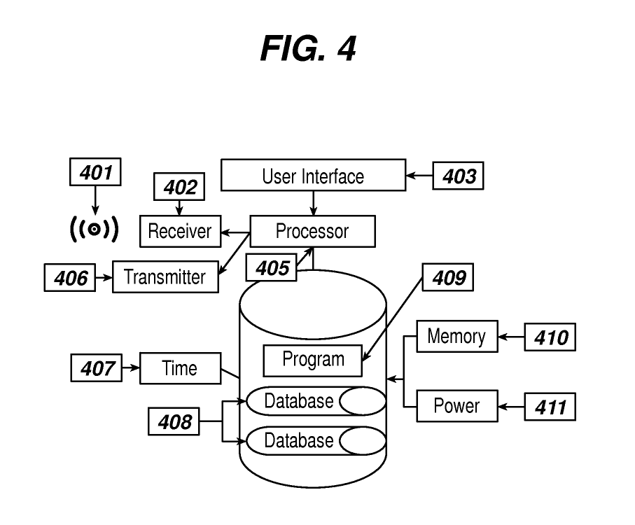

FIG. 4 is a schematic that illustrates a server that may be employed when using the method and system of the present invention. Referring now to FIG. 4, the server can contain deferent means of receiving information 401. For example, Bluetooth technology, network/internet capabilities, etc. A receiver 402 can be used to allow the processor 405 to cause the data to be stored in specific databases 408 in uniform format and time. The data can then be used by a software program 409 executable to perform the functions as described above by means of a series of algorithms. The server can additionally include a User interface 403, a processor for the software program 405, a means of power 411, memory 410, and a means of keeping real time 407 in relation to the specific location of the individual (e.g., connecting the User's cell phone to the system to change time accordingly when required due to the User traveling.) A transmitter 406 in logical communication with the processor 405 transmits one or more Holistic Messages to one or more Network Access Devices associated with the User (not shown) based upon the order of precedence, the NOW state and the priority of messages as described above.

The foregoing examples are not intended to limit the scope of the present invention, which may be set out in the claims. In particular, various equivalents and substitutions will be recognized by those skilled in the art in view of the foregoing disclosure and these are contemplated to be within the scope of the invention.

What is claimed is:

1. A method for providing personalized message delivery to one or more users, comprising:
gathering data descriptive of two or more events in the one or more users life, wherein said data is received from two or more sources, wherein said two or more sources include at least one third party, and wherein said at least one third party influences said personalized message delivery;
analyzing said data and said at least one third party influence to determine priority of said messages; and
providing said personalized message delivery to said at least one user.

2. The method of claim 1, further comprising correlating said data and said at least one third party influence to generate a holistic message; and
providing said holistic message to said at least one user.

3. A system for providing personalized message delivery to one or more users, comprising:
at least one user interface;
a server, wherein said server comprises software, wherein said software gathers data descriptive of two or more events in the one or more users life, analyzes said data to determine priority of messages, and employs said priority of messages to determine personalized message delivery of said messages to said one or more users;
wherein said data is received from two or more sources, wherein said two or more sources include at least one third party, and wherein said at least one third party influences said personalized message delivery; and
a transmitter in communication with said processor and said at least one user interface, wherein said transmitter provides said personalized message delivery of said messages to said one or more users through the at least one user interface.

4. Apparatus for providing information to a user, the apparatus comprising:
a computer processor in digital communication with a digital media storage device, wherein the digital media storage device stores executable software code; and
a transmitter in logical communication with the processor and also in logical communication with a communication network;
wherein, the software is executable upon demand and operative with processor to transmit and receive digital data via the transmitter and receive and store digital data records descriptive of events in a User's life,
wherein the digital data records are received from multiple disparate inputs and multiple disparate sources, the digital data records comprising a description of at least one Event, each respective Event influenced by one or more Pre-determined Third Parties;
wherein the software determines an order of precedence of Events and Third Party influences, receives data descriptive of a Now State of the User and generates a priority of messages; and
wherein one or more messages are transmitted to a network access device associated with the user based upon determined priority of messages.

5. The apparatus of claim 4, wherein the software is additionally operative allow additional inputs to influence the order of precedence.

6. The apparatus of claim 5, wherein the software is additionally operative to allow merging the additional inputs with the order of precedence of the user, learned responses and the Now State for the priority determination.

7. The apparatus of claim 4, wherein the software is additionally operative to allow an Overseer(s) to monitor the degree of influence of third parties.

8. The apparatus of claim 4, wherein the software is additionally operative to allow the intervention of one or more medical consultants.

9. The apparatus of claim 4, wherein the software is additionally operative to provide digital coaching.
